(19) United States
(12) Patent Application Publication
(10) Pub. No.: US 2006/0107753 A1
(43) Pub. Date: May 25, 2006

(54) Process for attaching flexible electrochemical sensors

(75) Inventor: Frank Mett, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: Dragerwerk Aktiengesellschaft, Lubeck (DE)

(21) Appl. No.: 11/286,106

(22) Filed: Nov. 23, 2005

(30) Foreign Application Priority Data
Nov. 24, 2004 (DE) 10 2004 056 516.3

(51) Int. Cl. G01N 3/08

(52) U.S. Cl. 73/818

(57) ABSTRACT

Process for attaching flexible electrochemical sensors, comprising at least the steps: provision of a surface, to which the sensor is to be attached; provision of an adhesive means at least on parts of the surface to which the sensor is to be attached and/or at least on parts of an outer limiting surface of the sensor, which ensures adhesion that securely fixes the sensor in case of flat contact between parts of the surface to which the sensor is to be attached and at least parts of the outer limiting surface of the sensor; pressing the sensor onto the surface to which the sensor is to be attached, so that the adhesive means is brought into flat contact at least with parts of the surface to which the sensor is to be attached and at least parts of the outer limiting surface of the sensor.

### CROSS REFERENCE TO RELATED APPLICATIONS

This application claims the benefit of priority under 35 U.S.C. § 119 of German Application DE 10 2004 056 516.3 filed Nov. 24, 2004, the entire contents of which are incorporated herein by reference.

### FIELD OF THE INVENTION

The present invention pertains to a process for attaching flexible electrochemical sensors.

### BACKGROUND OF THE INVENTION

Flexible sensors in the sense of the present invention are defined essentially as electrochemical sensors which can be noticeably deformed in case of the use of conventional attachment means. Sensors that have a housing or a capsule comprising polymer films are to be primarily considered here.

Electrochemical sensors are used to detect numerous chemical substances. Their basic design comprises at least one working electrode and a counterelectrode and optionally an additional reference electrode, which can communicate with one another via an electrolyte. It is significant for the accuracy of measurement and the reproducibility of the measurement results obtained by means of electrochemical sensors that a quasi-stationary state, which is possibly affected only by the substance to be detected, will develop in the interior of the electrochemical sensor. An especially sensitive range for the development of this quasi-stationary state is the borderline range between the electrodes and the electrolyte. A concentration gradient, which substantially affects the measurement result, develops in this range. To obtain reliable measurement results, it is important to ensure, especially after the running in or working in of the sensor, that these ranges are compromised as little as possible.

Any change in the wetting of the interface in the borderline range between the electrodes and the electrolyte ensures a change in the effective electrode surface. As a result, equalization processes will take place in the area of the boundary layer, e.g., due to the formation of a so-called new double layer, which is associated with a current flow, which can considerably compromise the measurement results at least temporarily. Changes take place in the wetting and the expression of the double layer, for example, after vibrations or relative changes in length between the sensor housing and a carrying structure, to which the sensor is attached. In particular, stresses caused by such relative changes in length are introduced as forces into the sensor structure and may lead, in case of rigid connections, to distortions of the sensor housing, which may gradually lead to a deformation of the sensor housing or to an abrupt change in position or a change in the shape of the sensor housing. Abrupt changes, in particular, lead to considerable temporary deviations of the measured signals and are absolutely unacceptable for the reliable use of electrochemical sensors.

Planar electrochemical gas sensors manufactured from flexible materials are especially susceptible to such effects. These are frequently encapsulated in housings made of polymer materials or films. Due to the construction, these lack high rigidity. As a consequence, movements of the electrolyte will occur in the sensor in case of mechanical stress, i.e., bending, vibration or the action of external pressures as well as tensile loads, and these movements lead to the aforementioned changes in the area of the boundary layer in front of the electrodes and hence to an undesired measurement error.

If such sensors are to be connected to a mobile device or stationary installations, such sensors are usually adapted by the punctiform or flat introduction of forces, by clamping or pressing on. However, this is precisely what leads to the undesired mechanical stress and the errors in the measured signal, which are associated with it.

### SUMMARY OF THE INVENTION

The object of the present invention is to provide a process for attaching electrochemical sensors, which ensures effective vibration damping, helps absorb stresses that occur, permits easy application, and can be manufactured in a simple manner.

According to the invention, a process is provided for attaching flexible electrochemical sensors. The process includes providing a surface, to which the sensor is to be attached. An adhesive means is provided at least on parts of the surface to which the sensor is to be attached, and/or at least on parts of an outer limiting surface. The adhesive ensures adhesion, which securely fixes the sensor in case of flat contact at least between parts of the surface to which the sensor is to be attached and at least parts of the outer limiting surface of the sensor. There is then a pressing of the sensor onto the surface to which the sensor is to be attached, so that the adhesive means is brought into flat contact at least with parts of the surface to which the sensor is to be attached and at least parts of the outer limiting surface of the sensor.

The essence of the present invention is that flexible electrochemical sensors are connected to a surface, to which the sensor is to be attached, over the largest area possible by means of an adhesive means. Such surfaces may be located on special device adapters, but they may also be provided on housing surfaces of different devices themselves or on different surfaces in and on buildings and many other application forms to be equipped with sensors.

It is advantageous to perform the attachment of the sensor via a stress-absorbing adhesive means. The flat connection by a stress-absorbing adhesive means ensures stress equalization. The stress absorption may take place due to an extensive elastic deformation of the adhesive agent or due to an at least partially plastic adaptation of the adhesive means to changed geometric conditions. The two mechanisms of the absorption of mechanical stresses can be combined without problems. It is important that the introduction of forces into the area of the stress-absorbing adhesive means does not lead to an appreciable passing through of the forces through the area of the adhesive means.

The attachment of the electrochemical sensor takes place, to a certain extent, in the form of a floating installation, which corresponds to a stress-equalizing and vibration-damping mounting of the sensor on an adhesive structure acting as a universal adapter.

The present invention comprises a process for attaching flexible electrochemical sensors, comprising at least the following steps:
providing a surface, to which the sensor is to be attached;
providing a an adhesive means at least on parts of the surface to which the sensor is to be attached and/or at least on parts of an outer limiting surface of the sensor;
pressing the sensor to the surface to which the sensor is to be attached, so that the adhesive means is brought into flat contact at least with parts of the surface to which the sensor is to be attached and at least with parts of the outer limiting surface of the sensor.

The adhesive means is selected to be such that it ensures adhesion, which securely fixes the sensor, in case of flat contact between at least parts of the surface to which the sensor is to be attached and at least parts of the outer limiting surface of the sensor. Such a fixation is defined in the sense of the present invention, among other things, as such a fixation that spontaneous relative movements between the sensor and the carrying surface are effectively reduced or prevented from occurring. The process can be combined with other attachment methods.

Besides the desired vibration damping and stress absorption, this process also makes it possible to apply the corresponding sensors extremely easily and to provide the adhesive means in a simple manner in terms of manufacturing technology. Due to the geometry of the areas in which the adhesive means is provided, the process according to the present invention can be further optimized. Thus, it is advantageous if the adhesive means is provided such that after the sensor has been attached, the adhesive means is located in the contact area between the surface to which the sensor is attached and the outer limiting surface of the sensor along a closed figure.

The adhesive means can thus be prevented from coming into contact with surface areas of the sensors on which it would be disturbing. On the other hand, effective vibration damping and stress absorption can also be achieved with such a geometry while the sensor is arranged with sufficient strength. If the sensor has no areas that are to be spared from contact with the adhesive means on the side on which the sensor is to be brought into contact with the adhesive means, it is especially advantageous if the adhesive means is provided such that after the sensor has been attached, the adhesive means is located in the entire contact area between the surface to which the sensor is attached and the outer limiting surface of the sensor. In addition, it is advantageous for the applicability of certain embodiments of electrochemical sensors if the adhesive means is provided such that after the sensor has been attached, the adhesive means acts only in the contact area between the surface to which the sensor is attached and elevated areas of the outer limiting surface of the sensor. This is especially advantageous if the areas of the sensor that are permeable to the substance to be detected are located on the same side on which the contact with the adhesive means, i.e., the attachment, is to take place. The sensor housing itself will thus protect the areas permeable to the substance to be detected, for example, from weather effects. Due to the elevated character of the contact areas, it is ensured at the same time that the areas of the sensor housing that are permeable to the substance to be detected are not covered by an excessively close contact with the surface to which the sensor is attached. Such an attachment is especially advantageous in case of high analyte concentrations, as they occur in case of oxygen measurements.

It is especially advantageous for the rapid applicability and rapid replaceability of electrochemical sensors if an adhesive means is used that makes possible the reversible attachment of the sensor. For example, a Velcro system may be used as the adhesive means for such a reversible attachment of the electrochemical sensor. In another advantageous embodiment of the process according to the present invention, an adhesive coating is used as the adhesive means to attach the electrochemical sensor.

The use of adhesive coatings makes possible numerous, especially simple applications of the process. For the application of electrochemical sensors in or on buildings, the adhesive means may be provided, for example, in the form of a coat of paint on the surface to which the sensor is to be attached. The adhesive strength can be guaranteed over a longer period of time by the suitable selection of materials forming an adhesive coating. The sensor itself is arranged now at the given time by simply placing it on the surface prepared according to the present invention and, if necessary, by briefly pressing it on, after which the firm contact between the sensor and the surface is established.

In an advantageous embodiment, the adhesive means is provided in the form of a coating on an outer limiting surface of the sensor. This coating may be provided, for example, only on elevated areas of the sensor housing or over the full surface on one side of the sensor. The sensor is likewise applied in this case by simply pressing onto the surface to which the sensor is to be attached.

Since there may be considerable time intervals between the manufacture of electrochemical sensors and their application, it is especially advantageous if the adhesive means is covered at least temporarily by a peelable film between the point in time at which it is provided and the attachment of the sensor. The adhesive action of the layer intended for the attachment is preserved for an especially long time in this manner.

Furthermore, it may be advantageous if the peelable film is arranged such that it covers the surface areas provided with the adhesive means and surface areas without adhesive means. The protective action of the film can thus be extended to beyond the areas that are provided with adhesive means. For example, areas that must remain permeable to substances that are to be detected can be protected from contamination or premature damage. On the one hand, the peeling off of the film before the attachment of the sensor exposes the adhesive means, i.e., for example, the adhesive coating, and at the same time opens the sensor surfaces kept open, which are necessary for the measurement proper. The sensor is activated, as it were, for the attachment and the measurement by peeling off the protective film.

The simple use of the process opens up new fields of application for such electrochemical sensors. The simple arrangement requires, as a rule, no specially trained personnel. An especially high reliability of application is achieved if the surfaces to which sensors are to be attached are color coded. Thus, different devices, in which a measurement of different substances is taken into consideration, can already be shipped with correspondingly color-coded surfaces at the time of shipping. The subsequent application of the necessary sensors is thus possible without problems. The color coding can be used as a coding to increase the safety against mix-ups in case of the use of different types of sensors.

A great variety of adhesive materials, as they are known, for example, from pressure-sensitive adhesive tapes, may be used as materials for the adhesive coating or adhesive means. The only thing that is to be borne in mind is that they shall have sufficient storage stability and that they shall not compromise the behavior of the electrochemical sensor. The thickness of the adhesive coating or the adhesive means should be selected on the basis of the criterion that relative changes in length that are to be expected between the sensor housing and the surfaces to which corresponding sensors are to be attached should be compensated possibly completely within the thickness of the adhesive layer. It is irrelevant in this connection whether this compensation is absorbed by a purely elastic deformation within the adhesive layer or by creep processes in highly viscous materials.

Another advantage of the attachment according to the present invention is that in case a relative change in length that occurs cannot be fully compensated, the large-area or full-area contact between the sensor and the receiving surface will effectively prevent the sudden lifting off or consequently an abrupt deformation of the sensor with the adverse consequences described.

The present invention shall be explained in greater detail on the basis of the example of the embodiment of electrochemical sensors that can be advantageously attached by the process according to the present invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a top view of a planar electrochemical sensor with a surface for adhesive coating;

FIG. 2 is a top view of an electrochemical sensor of a similar design with elevated areas of the outer limiting surface, which are provided with an adhesive coating; and

FIG. 3 is a view showing the sensor of FIG. 2 in a lateral sectional view.

### DESCRIPTION OF THE PREFERRED EMBODIMENTS

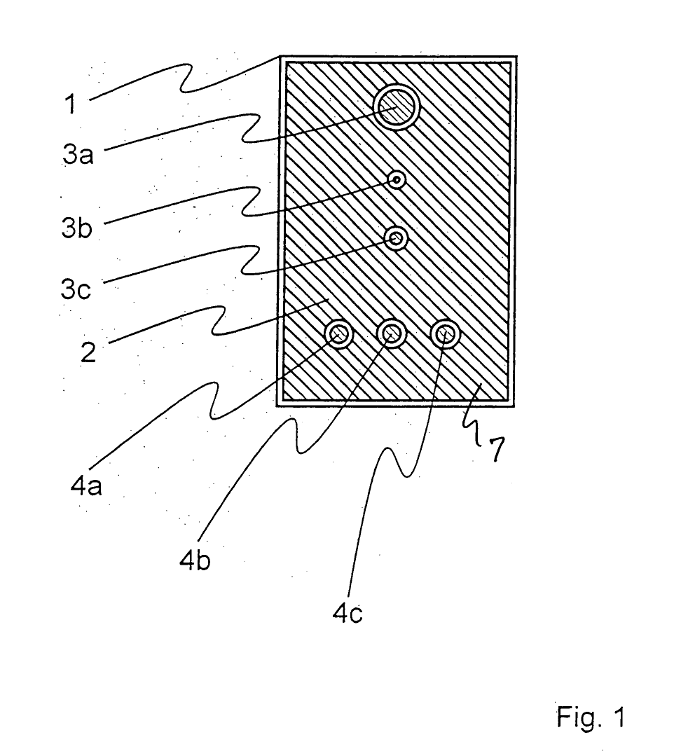

Referring to the drawings in particular, FIG. 1 shows a rectangular planar sensor 1 that has a film housing, which has various openings on one side. The surface 2 on the sensor housing, which is available, e.g., for an adhesive coating as an adhesive means, is represented by shading. The sensor is designed as a three-electrode sensor. The three electrodes 3a, 3b, 3c are located behind openings. Contact pads 4a, 4b, 4c, via which the electrodes 3a, 3b, 3c can be contacted, are arranged in three additional openings of the housing. If the sensor is attached on the side of the housing on which the openings are located, the areas of the openings must be kept free from adhesive means. If, by contrast, the sensor is attached on the side facing away from the openings, the surface 2 is available over its entire area for the application of the adhesive means 7. At least one of the openings for measuring the gas entering the sensor is located on the side of the sensor 1 facing away from adhesive means 7 shown in FIG. 1. In the alternative, if the sensor 1 is attached on the side of the housing on which the openings are located the surface on which the sensor 1 is fastened is provided with at least one flow channel (formed by a rim or, alternatively by ridges), such that at least one of the openings having a gas flow connection with the measuring electrode (3a, 3b, 3c) of the sensor 1 is in gas flow connection with the gas atmosphere surroundings of the sensor 1. An electrical connection with the contact pads 4a, 4b, 4c may be effected using contact needle elements, contact springs, spring finger connectors and electrically conductive rubber that make electrical contact with the pads 4a, 4b, 4c when the sensor 1 is fastened to the surface.

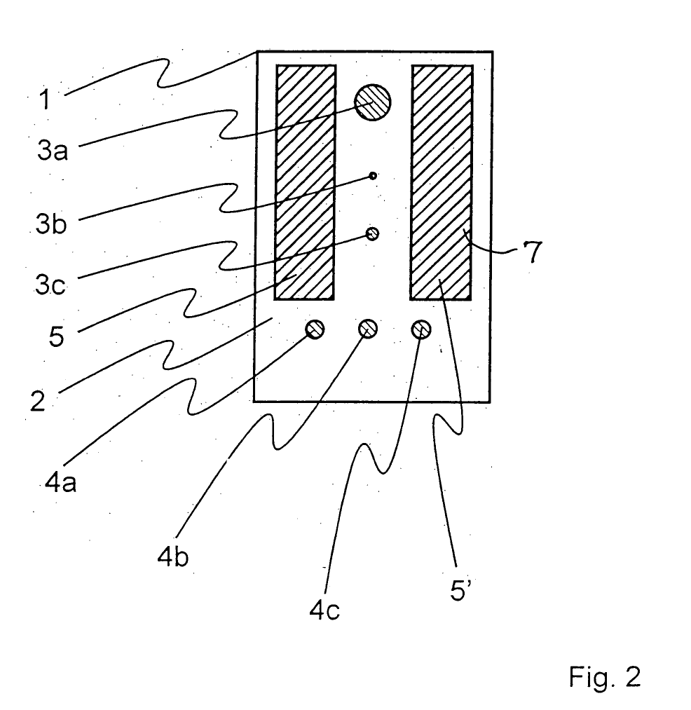

FIG. 2 shows a planar sensor 1, which has a similar design electrically but has two elevated areas 5 and 5′ extending lengthwise, which are provided with an adhesive means 7, along the outer limitation of the rectangular housing.

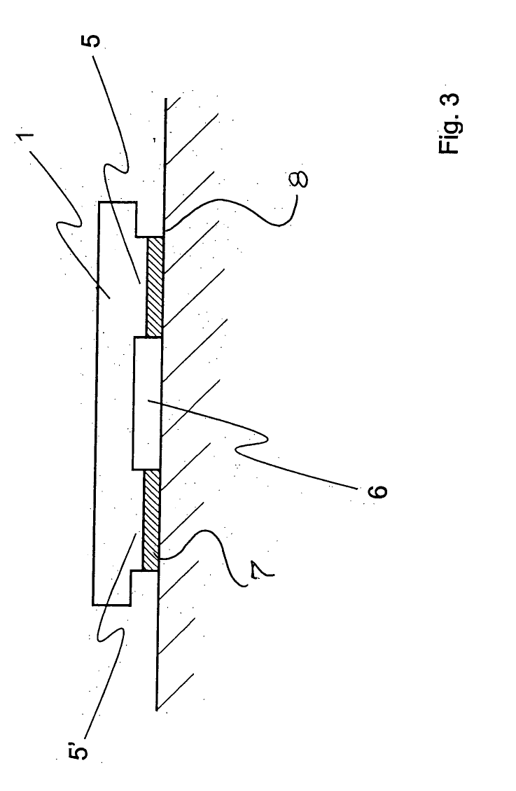

FIG. 3 shows a lateral sectional view of an identical electrochemical sensor. It becomes clear that only the adhesive means 7 on the elevated areas (contact areas) 5, 5′ come into contact with the surface to which the sensor is to be attached 8. A bridge structure is thus formed. The electrochemical sensor with its housing and the surface to which the sensor is attached enclose a cavity 6, in which the areas above the electrodes, which areas are permeable to the substances to be detected, are arranged in a protected manner, on the one hand, and, on the other hand, the access of the substances to be detected remains possible without problems through the cavity. Such arrangements are especially suitable for use in case of high analyte concentrations and under harsh conditions, for example, in outdoor areas.

All the sensors shown in FIGS. 1 through 3 can also be attached without problems if the adhesive means is provided on the surface on which the sensor is to be attached.

While specific embodiments of the invention have been shown and described in detail to illustrate the application of the principles of the invention, it will be understood that the invention may be embodied otherwise without departing from such principles.

What is claimed is:

1. A process for attaching flexible electrochemical sensor, the process comprising the steps of:
providing a surface, to which the sensor is to be attached;
providing an adhesive means at least on parts of the surface to which the sensor is to be attached, and/or at least on parts of an outer limiting surface of the sensor, which ensures adhesion, which securely fixes the sensor in case of flat contact at least between parts of the surface to which the sensor is to be attached and at least parts of the outer limiting surface of the sensor;
pressing the sensor onto the surface to which the sensor is to be attached, so that the adhesive means is brought into flat contact at least with parts of the surface to which the sensor is to be attached and at least parts of the outer limiting surface of the sensor.

2. A process in accordance with claim 1, wherein the adhesive means is provided such that after the sensor has been attached, the adhesive means is located in a contact area between the surface to which the sensor is attached and the outer limiting surface of the sensor along a closed figure.

3. A process in accordance with claim 1, wherein the adhesive means is provided such that after the sensor has been attached, the adhesive means is present in the entire contact area between the surface to which the sensor is attached and the outer limiting surface of the sensor.

4. A process in accordance with claim 1, wherein the adhesive means is provided such that after the sensor has been attached, the adhesive means acts between the surface to which the sensor is attached and elevated areas as contact areas of the outer limiting surface of the sensor.

5. A process in accordance with claim 1, wherein said adhesive means makes possible a reversible attachment for attachment and subsequent detachment of the sensor to the surface.

6. A process in accordance with claim 5, wherein a Velcro fastener is used as the adhesive means.

7. A process in accordance with claim 5, wherein an adhesive coating is used as the adhesive means.

8. A process in accordance with claim 7, wherein the adhesive means is provided in the form of a paint coat on the surface to which the sensor is to be attached.

9. A process in accordance with claim 7, wherein the adhesive means is provided in the form of a coating on an outer limiting surface of the sensor.

10. A process in accordance with claim 1, wherein the adhesive means is covered at least temporarily by a peelable film between the time it is provided and the attachment of the sensor.

11. A process in accordance with claim 10, wherein the peelable film is arranged such that it covers surface areas provided with the adhesive means and surface areas without adhesive means.

12. A process in accordance with claim 1, wherein the surface to which the sensor is to be attached is color-coded.

13. A process for attaching flexible electrochemical sensors, the process comprising: the steps of:
providing an electrochemical sensor with a housing having an outer limiting surface and with electrodes located behind respective openings in said outer limiting surface;
providing a surface, to which the sensor is to be attached;
providing an adhesive means for fixing the sensor to the surface;
positioning the adhesive means relative to the sensor and the surface;
pressing the sensor to the surface to which the sensor is to be attached with the adhesive means between the surface to which the sensor is to be attached and said outer limiting surface, so that the adhesive means is brought into flat contact at least with parts of the surface to which the sensor is to be attached and at least parts of the outer limiting surface of the sensor.

14. A process in accordance with claim 13, wherein the adhesive means is provided such that after the sensor has been attached, the adhesive means is located between the surface to which the sensor is attached and the outer limiting surface of the sensor along a contact area that forms a closed shape.

15. A process in accordance with claim 13, wherein the adhesive means is provided such that after the sensor has been attached, the adhesive means is present in a contact area between the surface to which the sensor is attached and the entire outer limiting surface of the sensor.

16. A process in accordance with claim 13, wherein the outer limiting surface of the sensor includes elevated areas as contact areas with said adhesive means provided, after the sensor has been attached, between the surface to which the sensor is attached and the elevated areas as contact areas.

17. A process in accordance with claim 13, wherein said adhesive means comprises one of:
hook and loop fasteners or another a reversible attachment structure for attachment and subsequent detachment of the sensor to the surface; and
an adhesive coating.

18. A process in accordance with claim 13, wherein the adhesive means is covered at least temporarily by a peelable film between the time it is provided and the attachment of the sensor.

19. A process in accordance with claim 18, wherein the peelable film is arranged such that it covers surface areas provided with the adhesive means and the openings or surface areas without adhesive means.

20. A process for attaching flexible electrochemical sensors, the process comprising the steps of:
providing an electrochemical sensor with a housing having an outer limiting surface and with electrodes located behind respective openings in said outer limiting surface;
providing an positioned adhesive covering at least parts of the outer limiting surface;
covering the positioned adhesive with a peelable film;
providing a surface, to which the sensor is to be attached;
moving the sensor to the surface, to which the sensor is to be attached, and peeling off the peelable film; and
pressing the sensor onto the surface, to which the sensor is to be attached, so that the adhesive means is brought into flat contact at least with parts of the surface, to which the sensor is to be attached, and at least parts of the outer limiting surface of the sensor.

21. A process in accordance with claim 20, wherein the peelable film is arranged such that it covers surface areas provided with the adhesive and the openings or surface areas without said adhesive.
